(19) United States
(12) Patent Application Publication
(10) Pub. No.: US 2005/0225635 A1
(43) Pub. Date: Oct. 13, 2005

(54) Video based security system

(75) Inventors: Thomas J. Meitzler, Troy, MI (US); Samuel E. Ebenstein, Southfield, MI (US); Gregory H. Smith, Ann Arbor, MI (US); James S. Rankin II, Novi, MI (US); Yelena M. Rodin, Southfield, MI (US)

Correspondence Address: U.S. ARMY TACOM;ATTN: AMSTA-LP/281, 6501 E. 11 MILE RD., WARREN, MI, 48397-5000, US

(73) Assignee: The United States of America as represented by the Secretary of the Army, Washington, DC (US)

(21) Appl. No.: 10/828,525

(22) Filed: Apr. 9, 2004

(51) Int. Cl. H04N 7/18

(52) U.S. Cl. 348/148; 348/143

(57) ABSTRACT

A video surveillance system for vehicle interiors that has a plurality of video cameras positioned throughout the vehicle connected to a multiplexer to route the signals to an image processing system. The system will build a high resolution image and display the image real-time for review.

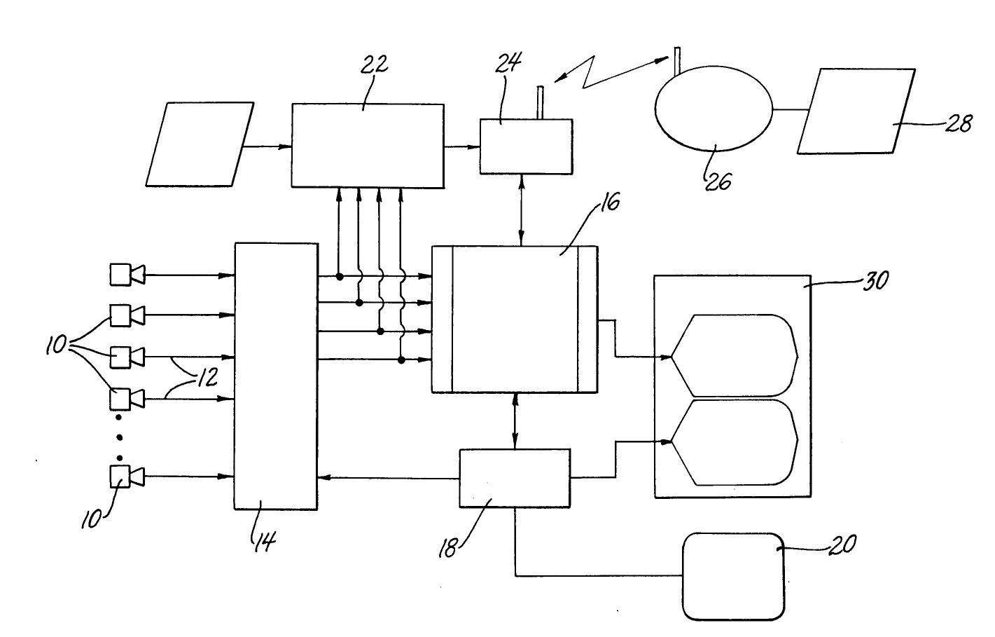

### GOVERNMENT INTEREST

The invention described here may be made, used and licensed by and for the United Sates Government for governmental purposes without paying us any royalty.

### BACKGROUND OF THE INVENTION

In one aspect this invention relates to security camera systems. In a further aspect this invention relates to video imaging technology using a plurality of cameras.

Security systems are finding an ever increasing usage in monitoring real estate installations. Such systems can range from one or two cameras in a small store up to dozens of cameras covering a large mall or building. In general these systems display the video signals as discrete individual pictures on a number of display panels. When there are a large number of cameras, greater than the number of display panels, the systems have a control means that changes the input signal to the displays so as to rotate the images and scan the entire video coverage within a predetermined time frame. Such systems also usually have means to stop the progression of the image sequence to allow study of a particular area of interest. Such systems have proved useful in monitoring areas and frequently result in the identification of criminal activity.

Some of these prior art systems have an associated scene stitching program that combines the static images produced by the cameras into a larger static image showing a greater amount of area in one view. These systems however can only produce a static image of low resolution which is of limited use in identifying hazardous situations particularly before they become overt.

The present systems approach visual security as a series of discrete images of a specific defined zone. The present invention contemplates providing a visual security view which is an integrated view of the area to be monitored in real time on the order of milliseconds and which has increased resolution This type of view would be particularly valuable for monitoring a vehicle interior such as civilian aircraft, rail transportation, buses and subways. The integrated view will provide better surveillance particularly in vehicles and other enclosed spaces that have become more important in recent times.

### SUMMARY OF THE INVENTION

A video surveillance system for use in a vehicle interior according to this invention includes a plurality of miniature, high resolution video cameras disposed as a camera matrix each generating a video signal. The cameras are positioned throughout the vehicle's interior so as to cover an entire area of interest, generally the passenger section of the vehicle. The cameras are chosen so they can acquire imagery even under very low light conditions. If desired, special low light and/or infrared cameras could be mounted as part of the camera matrix array for very low light conditions such as a darkened passenger cabin. A video multiplexer receives the individual signals from each camera and routes the video signals to a processing center or device. The imaging processing system will receive the video signals from the multiplexer and stitches the video signals together to generate and provide a single coherent image of the vehicle interior, contents, and occupants. An image enhancement system is available to receive images and build a very high resolution image from multiple frames of the video signal. A controller is provided which allows an operator to change the image being processed so as to view in greater depth and magnification of a particular portion of the interior scene. A control computer will coordinate the various components of the system and generate an image for display.

### BRIEF DESCRIPTION OF THE DRAWINGS

In the accompanying drawing:

The FIGURE is a flow diagram of one system according to this invention.

### DETAILED DESCRIPTION

Referring to the accompanying drawing wherein like numerals refer to like parts, a video surveillance system according to this invention is depicted for use in a vehicle interior, such as the cabin of an airplane. A plurality of video cameras 10 are distributed about the cabin interior. Each camera will be mounted in a concealed position, high quality optical and infrared cameras being presently available which are about the size of a lipstick case. The cameras 10 each cover an area of about 30 degrees and would be positioned throughout the cabin's interior so as to cover the entire area in an overlapping pattern. The summation of all the cameras 10 will generate a video signal of the entire desired coverage area.

The signals generated by the cameras 10 are sent via a plurality of connections 12 to a video multiplexer 14, which receives and routes each individual video signal to the desired processing center or device. As shown, the signals from the multiplexer 14 can be routed first to an imaging processing system 16 which will receive the individual video signals from the multiplexer and stitch the video signals together in a matter of milliseconds. Stitching the video signals together at the interfaces where the cameras signals overlap creates a single continuous coherent image of the cabin's contents, and occupants. Real time, dynamic stitching can be achieved using commercially available video cards and software and the exact method chosen is not part of this invention. When a particular area of the cabin merits additional special attention, the image processing 16 can also provide software zooming and panning capabilities to provide a larger image and/or sweep the desired area. This is accomplished using a controller 18 which is under the manual direction of a user (not shown). The user has one or more interface devices 20 which can be one or more normal computer interfaces such as a mouse, keyboard, or joy stick, the particular interface device being chosen based on space limitations and similar operating conditions where the controller 18 and interface 20 are located.

An image enhancement system 22 is also available to receive images from the multiplexer. The image enhancer 22 builds a very high resolution image from multiple frames of the video signal and can further compress and store the images. As shown, the image enhancer 22 has an output to a transceiver 24 that will transmit the enhanced image to a receiver 26 at a different location. Where the invention is being used to monitor an a vehicle, such as an airplane cabin, the image could be relayed to a central ground base 28. At the central ground base 28, the signal can be displayed on a screen allowing the central ground base to make informed decisions on occurrences in the cabin. In addition, to displaying on a screen the image files can be used as data input for comparison with a centralized data base of known potential problems maintained at or available to the central ground base 28.

The image processing system 16 sends a video signal to a user display 30. The display 30 can be on the vehicle, such as a flat panel display near the operator or located near security personnel. It is expected the newer, thinner organic displays being developed will allow a display to be mounted virtually anywhere. A display could also be mounted at the central ground base 28. Of course, multiple displays could be used to allow real time interaction between the vehicle operators and the ground station.

The controller 18, which is a computer, preferably a personal type computer, provides the means by which an operator can change the image being processed so as to view in greater depth and magnification a particular portion of the interior scene. The computer will coordinate the various components of the system and generate an image for display. As part of the image the computer can generate an iconic representation of the vehicle interior to show the location of various objects and persons within the cabin

Various alterations and modifications will become apparent to those skilled in the art without departing from the scope and spirit of this invention and it is understood this invention is limited only by the following claims.

1. A video surveillance system for use in a vehicle interior including:
a plurality of video cameras generating video signals positioned throughout the vehicle interior so as to cover an entire area of interest;
a video multiplexer that routes the video signals;
an imaging processing system that receives the video signals from the multiplexer and stitches the video signals to provide an image of the vehicle interior;
an image enhancement system capable of building a very high resolution image from multiple frames of video signal;
a controller which allows an operator to change and control the image being processed;
a control computer which coordinates the various components of the system; and
an image display for receiving and displaying the image output from the processor for review.

2. the video system of claim 1, wherein the image enhancing system has means to display an iconic representation of the vehicle interior on the image display so as to relate the portion of the interior being shown on the image display to the overall vehicle interior.

3. The video system of claim 2 wherein the iconic representation is a geometric seating layout of the vehicle interior in which individual occupants are imaged.

4. The video system of claim 1 having a transceiver attached to the processor whereby the processor can broadcast and receive information from outside the vehicle.

5. the video monitoring system of claim 1 having near infrared illuminators to provide signals from the video cameras even when the vehicle interior is darkened.

6. the video monitoring system of claim 1, having a ticket database containing information on ticketed passengers in the vehicle.

7. the video monitoring system of claim 1, further including a centralized data base containing data related to various types of potential security problems that can be queried using the transceiver.

8. A video surveillance system for use in a vehicle interior including:
a plurality of video cameras generating video signals positioned throughout the vehicle interior so as to cover an entire area of interest;
a plurality of near infrared illuminators to provide infrared imagery even when a darkened vehicle interior exists;
a video multiplexer that routes the video signals;
an imaging processing system that receives the video signals from including signals in the near infrared spectrum from the multiplexer and stitches the video signals to provide an image of the vehicle interior;
an image enhancement system capable of building a very high resolution image from multiple frames of video signal, the image enhancing system having means to display an iconic representation of the vehicle interior superimposed on the image being displayed so as to provide visual orientation to a viewer of the particular location of the interior being displayed;
a controller which allows an operator to change and control the image being processed;
a control computer which coordinates the various components of the system; and
an image display for receiving and displaying the image output from the processor for review.

9. The video system of claim 7 having a transceiver attached to the processor whereby the processor can broadcast and receive information from outside the vehicle

10. the video monitoring system of claim 7, having a ticket data base containing information on ticketed passengers in the vehicle and further having a centralized data base containing data related to various types of potential security problems that can be queried using the transceiver.

11. A video surveillance system for use in a vehicle interior including:
a plurality of video cameras generating video signals positioned throughout the vehicle interior so as to cover an entire area of interest;
a video multiplexer that routes the video signals;
an imaging processing system that receives the video signals from the multiplexer and stitches the video signals to provide an image of the vehicle interior;
an image enhancement system capable of building a very high resolution image from multiple frames of video signal;
a controller which allows an operator to change and control the image being processed;
a ticket database containing information on the ticketed passengers on the vehicle;
a control computer which coordinates the various components of the system; and an image display for receiving and displaying the image output from the processor for review.

12. the video system of claim 1, wherein the image enhancing system has means to display an iconic representation of the vehicle interior on the image display so as to relate the portion of the interior being shown on the image display to the overall vehicle interior.

13. The video system of claim 10 having a transceiver attached to the processor whereby the processor can broadcast and receive information from outside the vehicle.

14. the video monitoring system of claim 10 having near infrared illuminators to provide signals from the video cameras even when the vehicle interior is darkened.
